(19) United States
(12) Patent Application Publication
(10) Pub. No.: US 2003/0218400 A1
(43) Pub. Date: Nov. 27, 2003

(54) Induction motor and method of providing axial flow in a submerged induction motor

(76) Inventor: Dennis L. Rimmel, Cypress, CA (US)

Correspondence Address: Timothy E. Nauman, Esq., Fay, Sharpe, Fagan,, Minnich & McKee, LLP, 7th Floor, 1100 Superior Avenue, Cleveland, OH, 44114-2518, US

(21) Appl. No.: 10/155,571

(22) Filed: May 24, 2002

(51) Int. Cl. H02K 17/00

(52) U.S. Cl. 310/166; 310/211

(57) ABSTRACT

A motor having a rotor with a plurality of grooves extending generally longitudinally along an outer surface of the rotor. A cross-sectional shape of the rotor outer surface generally corresponds to the shape of an outer boundary of a flux pattern that is developed in the rotor during operation. A plurality of slots extend longitudinally along the same general direction as the grooves and are positioned in a spaced relationship to the outer surface of the rotor and the grooves. The grooves and/or slots extend in a skewed or generally helical direction along the length of the rotor to enhance pumping action.

### BACKGROUND OF INVENTION

This invention relates to rotating cylinders (i.e., rotors) and stators for induction motors. It finds particular application in conjunction with induction motors that are submerged in fluid or gas and operating at cryogenic temperatures and will be described with particular reference thereto. However, it is to be appreciated that the invention is also amenable to other applications.

Typically, a rotor has slots running longitudinally along the same general direction as a rotor shaft. It is common in these rotors for an outer, cylindrical surface of the rotor to be generally smooth and continuous. The longitudinal slots may be tear drop shaped with a rounded top and a rounded bottom. A bridge over the slots is often closed; however, it is also common for rotors to have an open bridge at the end of the slots. If the rotor has open bridges, the cylindrical surface of the rotor has gaps at each open bridge rather than a continuous surface.

Typically the length of the rotating rotor in induction motors that are submerged in a fluid or gas makes axial fluid or gas transfer between the outer cylindrical surfaces of the rotor and a corresponding stator difficult. Increasing a magnetic air gap between the rotor and the stator to aid axial flow of the fluid or gas reduces the torque of the motor and is limited by the required magnetically induced torque characteristic for the motor.

A simplified flux pattern for rotating rotors is saturated at the bridges of the rotor, but expands in the tooth portion (i.e., rotor bar) between the slots. The flux is pulsating and effectively moving along the outer cylindrical surface of the rotor from one rotor bar to another rotor bar at a torque dependent, slip frequency relative to the stator. The non-symmetrical flux along the outside cylindrical surface causes additional surface flux losses.

Thus, there is a particular need for induction motors with rotors that have reduced flux losses. There is also a particular need for induction motors submerged in fluid or gas with rotors that have improved fluid or gas transfer features. Accordingly, there is also a particular need for such rotors for use in such induction motors.

### BRIEF SUMMARY OF INVENTION

The invention contemplates rotors with a portion of the surface removed, motors including such rotors, and a method of providing axial flow of fluid or gas in an induction motor submerged in fluid or gas which overcomes one or more of the above-mentioned problems and others.

In one aspect of the invention, a rotor with a portion of the surface removed is used in conjunction with a stator in an induction motor that is submerged in a fluid or gas. The rotor cooperates with the stator to produce a magnetic field and to facilitate fluid or gas transfer between the surfaces of the rotor and the stator along the axial length of the rotating rotor within the motor.

In another aspect of the invention, a portion of an outer surface of the rotor is removed creating a plurality of grooves running generally longitudinally along the outer surface of the rotor. Preferably, a cross sectional shape of the outer surface of the rotor generally corresponds to the shape of an outer boundary of a flux pattern that is developed in the rotating cylinder when the induction motor is operated.

In another aspect of the invention, the rotor includes a shaft, an outer surface, and a plurality of slots. The shaft runs along the axis of the rotor and a plurality of grooves extend longitudinally in the same general direction as the shaft. A cross sectional shape of the outer surface generally corresponds to the shape of an outer boundary of a flux pattern that is developed in the cylinder when the motor is operated. The slots are positioned in a spaced relationship to the outer surface of the rotor and the grooves in the outer surface of the rotor.

In still another aspect of the invention, a method of providing axial flow of gas in an induction motor submerged in gas is provided. The method includes the steps of operating the motor to cause a rotor to rotate about a cylindrical axis of the rotor, and pumping gas along the axial length of the rotor through spiral grooves in an outer surface of the rotor.

One advantage of the invention resides in improved fluid or gas flow along the axial length of the rotor between the rotor and the stator.

Another advantage of the invention is found in increased magnetic utilization and symmetry of the induced or primary magnetic fields in the rotor, thereby reducing surface flux losses.

Still other features and advantages of the invention will become apparent to those of ordinary skill in the art upon reading and understanding the description of the invention provided herein.

### BRIEF DESCRIPTION OF DRAWINGS

The invention is described in more detail in conjunction with a set of accompanying drawings.

FIG. 1A is a longitudinal cross-section of a motor assembly.

FIG. 1B illustrates a cross-section of a conventional rotor and stator assembly.

FIGS. 1C and 1D show conventional closed and open bridge arrangements in a rotor.

FIG. 2 illustrates a cross-section of a rotor and stator assembly in accordance with the present invention.

FIGS. 3A-3N show various slot shapes that may be employed in a rotor.

FIGS. 4A and 4B are plan and side views, respectively, of a rotor in accordance with the present invention.

FIG. 5 is a perspective view of a rotor formed in accordance with present invention.

FIGS. 6A-6C illustrate alternative embodiments of the present invention.

FIG. 7 is a longitudinal cross-section through a rotor.

### DETAILED DESCRIPTION

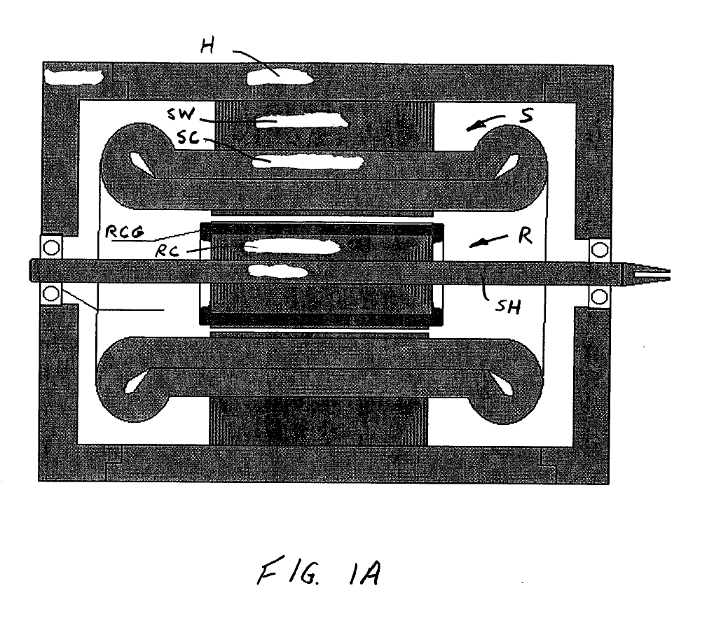

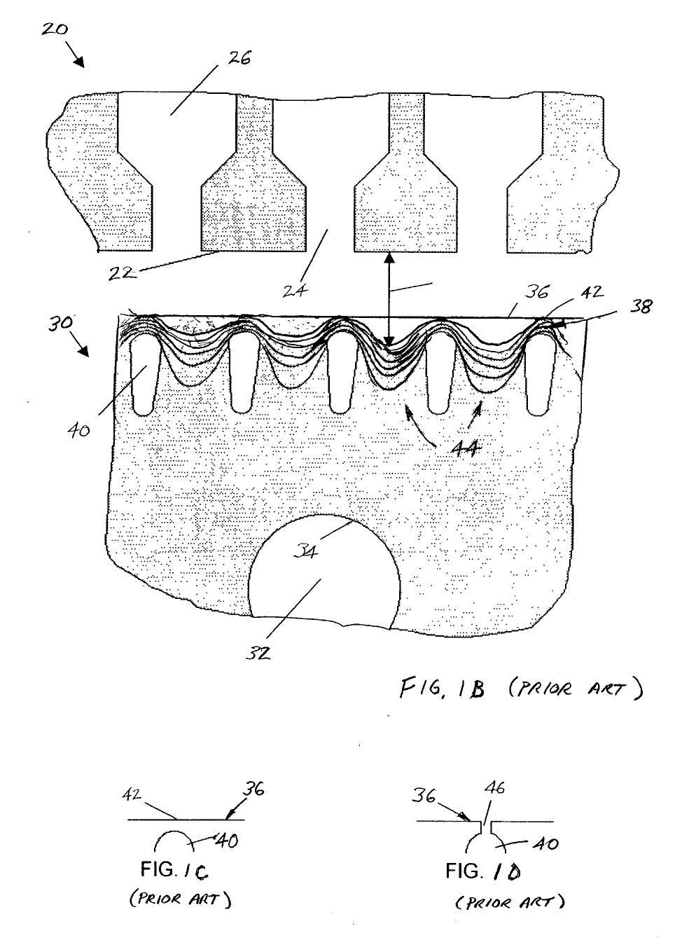

Referring to FIG. 1A, a conventional motor assembly as used in a submersible motor, i.e., an electrical motor submerged in a fluid such as a gas or liquid, is generally known in the art. A housing H encloses a rotor assembly R that includes a rotor core RC and a rotor cage RCG operatively received on a rotatable shaft SH. The shaft is supported in the housing by a bearing assembly, shown here as first and second bearings disposed at opposite ends of the housing. For example, the bearings are roller bearing assemblies, although it will be appreciated that other suitable bearing assemblies may also be used. The rotor assembly and shaft rotate in response to an electromagnetic force imposed by stator assembly S that includes a stator core SC and stator winding SW. As briefly noted above, the motor assembly finds application in wide variety of conventional motor applications and also finds particular application in rotatably driving a pump (not shown). Examples of motor assemblies of this general type used to drive pumps in a submersible or cryogenic environment can be found in U.S. Pat. Nos. 4,636,672; 4,672,249; 4,749,894; and 5,582,017. However, the invention is not intended to be limited to this environment and may find application in related environments and applications that encounter similar problems and can advantageously adopt one or more of the advantages of the present invention.

As noted in the Background, fluid transfer along the surface of a rotor is an important issue, as well as maintaining a desired proximity between the rotor and stator of the motor. As represented in FIG. 1B, stator 20 has a first or inner face 22 that is periodically interrupted by openings 24 that communicate with stator slots 26. A rotor 30 is operatively secured to a shaft 32 along an inner surface 34 for rotation relative to the stator. The rotor has a second or outer surface 36 that defines a generally smooth surface.

A flux pattern 38 is represented in FIG. 1B. As will be appreciated, the flux lines are concentrated between the surface 36 and slots 40 that are circumferentially spaced through the rotor. Here, the slots 40 have a teardrop shape, although it will be appreciated that other shapes may also be used and as will be decribed below. At those regions between the slots, the flux line forms a trough that is spaced from the surface 36 of the rotor. This creates a wave pattern around the rotor. The flux is saturated in the bridge portion 42 and expands in a tooth portion 44 located between the slots. As noted in FIGS. 1C and 1D, the inner surface 36 may be continuous (FIG. 1C) and thus includes bridge portions 42 located over the outer radial ends of the individual slots 40 or may include openings 46 that communicate between the outer surface 36 and the slots 40.

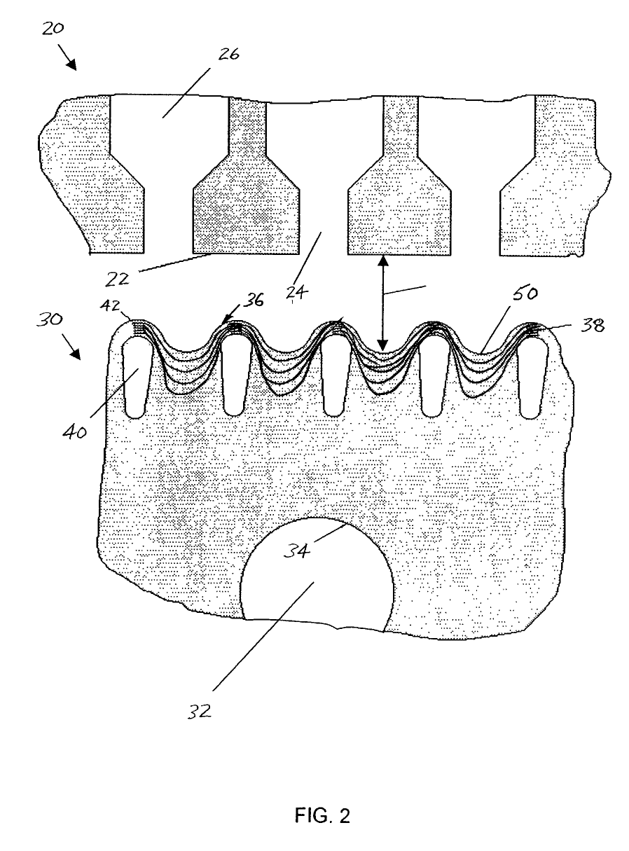

In a preferred embodiment of the present invention as shown in FIG. 2, material is removed from the rotor to form grooves 50 in the outer surface 36 of the rotor. As will be appreciated from a comparison of FIG. 1B with FIG. 2, the depth and contour of the grooves 50 follows the flux pattern. In this manner, the resultant magnetic flux pattern is improved. The net effect also increases the magnetic air gap between relative rotating magnetic fields of the rotor and stator, while maintaining the relative distance of the current carrying rotor. Increases in the magnetic air gap, while maintaining the torque inducing current, effectively increases torque and decreases surface losses which improves input/output efficiency. In the embodiment of FIG. 2, the rotor slots 40 are equally sized, and equi-spaced about the rotor. Likewise, the removed material or grooves 50 also follow a symmetrical, equi-spaced arrangement.

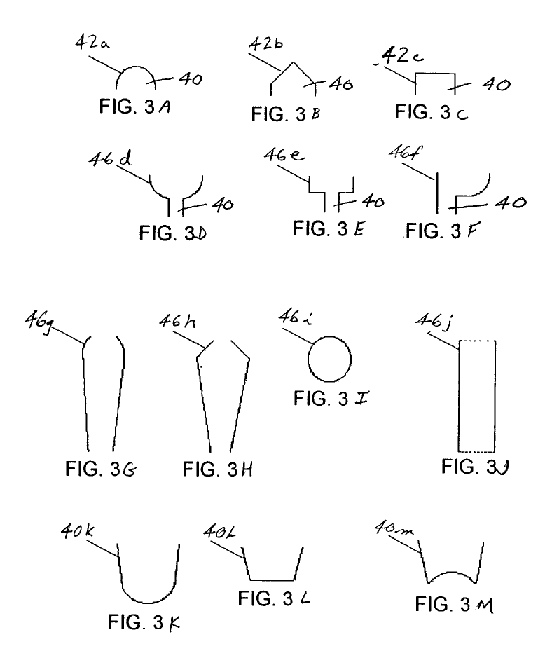

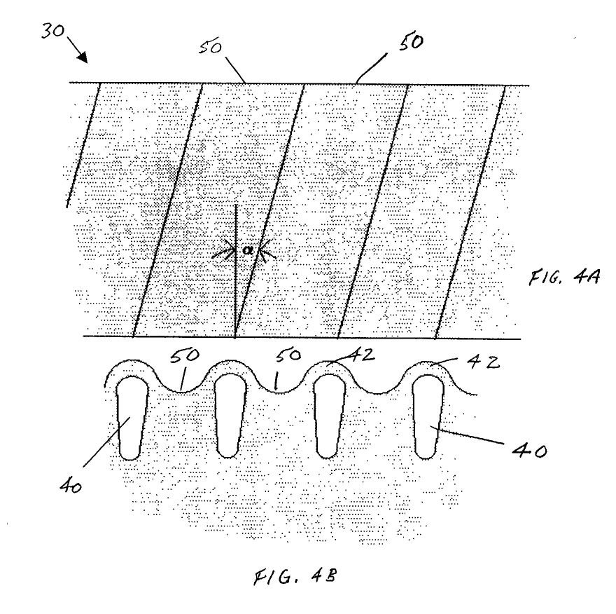

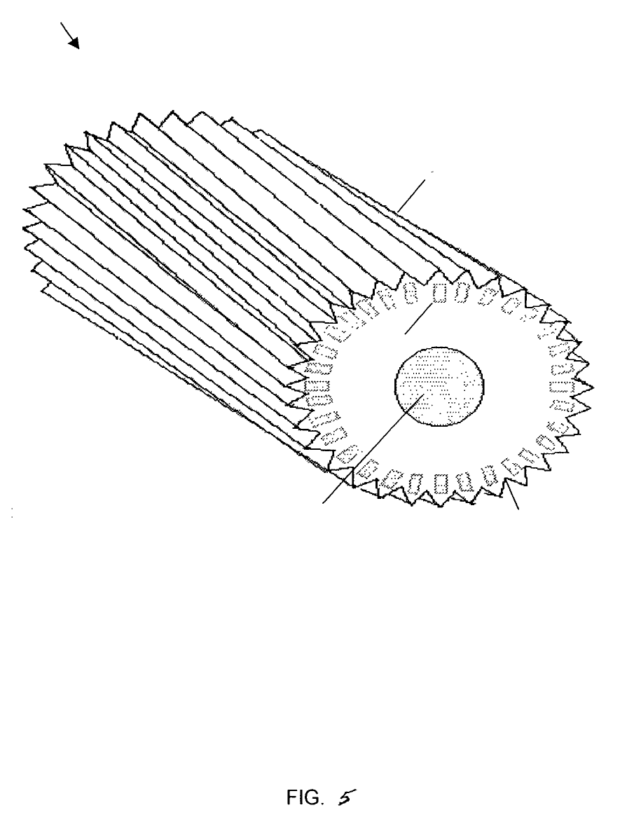

The particular shape and location of the slots may alter the flux characteristics of the rotor. For example, FIGS. 3A through 3M illustrate alternative open and closed slots. Three closed slot configurations are shown in FIGS. 3A through 3C. A semi-circular, or rounded shape 42a is exemplified in FIG. 3A, a pinched or pointed end 42b in FIG. 3B, and a flat end 42c shown in FIG. 3C. The lower portion of the slots is not illustrated since it may vary as desired. FIGS. 3D-3H illustrate double cage designs having an opening that communicates with the slot. For example, FIG. 3D illustrates a rounded opening 46d, while FIG. 3E illustrates a rectangular shape opening 42e, and FIG. 3F is a skewed opening 46f. FIGS. 3G through 3J show various bottom cage designs. For example, in FIG. 3G, a generally teardrop arrangement 46g is illustrated. A coffin-shape 46h is illustrated in FIG. 3H, and a round or bar shape 46i is shown in FIG. 31. Last, a rectangular bar 46j is also illustrated in FIG. 3J.

Still further, the slot bottom portion can adopt various configurations as represented in FIGS. 3K through 3M. Thus, a rounded version 40k is shown in FIG. 3K and a flat slot bottom 401 in FIG. 3L, while a concave bottom portion 40m is demonstrated in FIG. 3M.

FIGS. 4A and 4B demonstrate that the slots need not extend solely in a longitudinal or axial direction. That is angle shown in FIG. 4A illustrates the skew or angle at which the slots 40, and likewise the grooves 50 extend over the rotor in a generally helical pattern. Spiraling the ridged surface relative to the rotor axis provides a pumping action that aids in actual flow of fluid and gases through the motor. Of course, the angle may be varied as desired for a particular application and as will become more apparent below, the rotor slots and grooves may have a non-symmetrical relation also.

FIG. 5 provides a perspective view of the skewed external grooves in the rotor of FIGS. 4A and 4B. As will be appreciated, the slots extend in a generally helical fashion over the length of the rotor, i.e., from one end to the other, and the external surface of the rotor has a generally corrugate shape. Thus, the ridge surface that is skewed relative to the longitudinal axis of the rotor provides the advantageous pumping action that assists in the axial flow of fluid and gases between the rotor and stator. Grooving the surface of the rotor between the slots also improves the magnetic flux pattern without enlarging the relative distance of the rotor from the stator. The net effect, however, is to increase the magnetic air gap between the relatively rotating magnetic fields of the rotor and stator which effectively increase torque and decreases the surface losses. Ultimately, the input/output efficiency of the motor is increased.

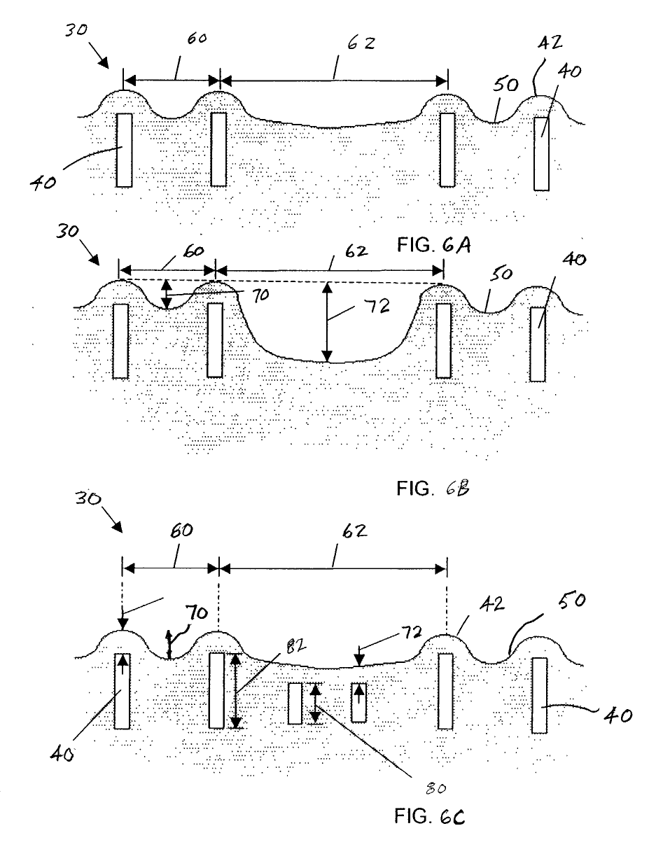

FIGS. 6A through 6C illustrate still other variations that may be provided in the rotor surface. For example, FIG. 6A includes generally rectangular slots 40 in the rotor that include rotor slot bridges 42 over the outer radial ends of the slots. Here, however, the spacing x between selected slots is different than the spacing y between other slots. The non-symmetrical slot spacing increases the pumping action as the rotor rotates. Similarly, in FIG. 6B, the slots are non-symmetrically spaced and the depth of the grooves may vary from a shallow height 70 to an increased depth 72. The different depths can be used in conjunction with the different spacings 60, 62. The increased perimeter distance 62 allows the increased depth 72 of the groove because of the altered flux pattern encountered by the increased distance between the slots. The increased depth advantageously allows improved movement of fluid along the external surface. It will also be appreciated that the grooves can be longitudinal or skewed, and that the slots may adopt a wide variety of configurations than those illustrated in these FIGURES.

FIG. 6C demonstrates that the slots need not all be the same size within the rotor. Here, all of the slots are generally rectangular shaped and include bridges over the outer radial ends of the slots. It will be appreciated, however, that non-symmetrical slot spacing and different slot sizes can be used to provide desired pumping action or alter the electrical characteristics of the motor. Thus, a slightly increased depth 72 is achieved adjacent the smaller sized slots having a length 80 relative to the enlarged slots 82. In addition, the different spacing 60, 62 of the slots can still be accommodated.

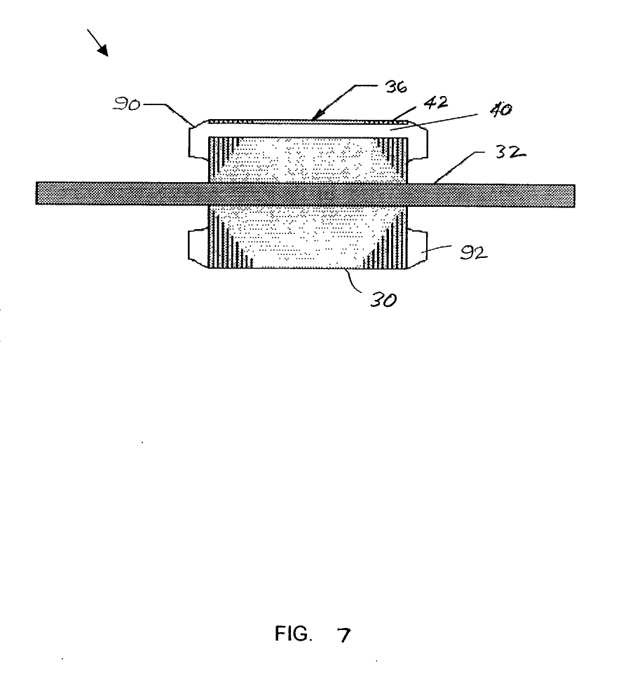

In FIG. 7, a cross-section through a rotor formed in accordance with the present invention is shown. The rotor includes the grooves as is apparent in the upper half of the drawing, and as will be appreciated, the grooves are unskewed for purposes of clarity. End rings 90, 92 are provided at opposite ends of the rotor. The end rings vary in their dimension, i.e., the end rings increase in the radial dimension as they extend toward the central portion of the rotor and act as an inducer for the pumping action achieved with the rotor of the present invention. A rotor is mounted on the shaft 32 for rotation and the elongated slot 40 is closed along its outer radial surface by bridge 42.

It will also be appreciated that slots are oftentimes filled with a preselected material such as aluminum, aluminum alloy, copper, copper alloy, brass, and bronze. These materials provide desired flux properties for the motor. Moreover, the materials are used for various properties such as light weight, durability, conductivity, etc. In addition, it is contemplated that high resistance, non-metallic material can be used in applications of extreme temperatures and viscous variations.

The invention should not be limited to the embodiments shown and described herein. For example, the invention also applies to rotors without slots, commonly called solid core rotors and cageless laminated rotors. These types of rotors are used in low temperature and high temperature superconductivity applications. Normally smooth bore rotors used in these types of applications encounter difficulty in producing desired torque since the torque is produced as a function of the resistance. The low resistance effectively reduces the torque. By eliminating slots in the rotors, the present invention still improves the torque and maintains a more consistent surface temperature which improves the mechanical/electrical performance of the motor.

The invention has been described with reference to the preferred embodiments. Obviously, modifications and alterations will occur to others upon a reading and understanding of this specification. It is intended that the invention be construed as including all such modifications and alterations insofar as they come within the scope of the appended claims or the equivalents thereof.

What is claimed is:

1. An induction motor, including:
a stator; and
a rotor that rotates when the induction motor is operated, wherein a portion of an outer surface of the rotor is removed creating a plurality of grooves extending generally longitudinally along the outer surface of the rotor in the same general direction as an axis of the rotor.

2. The motor of claim 1 wherein a cross sectional shape of the outer surface of the rotor generally corresponds to the shape of an outer boundary of a flux pattern that is developed in the rotor when the induction motor is operated.

3. The motor of claim 1, wherein the grooves of the cylinder are skewed at an angle to the axis of the cylinder.

4. The motor of claim 1, further including a plurality of slots extending generally longitudinally through the rotor.

5. The motor of claim 4, wherein the grooves and slots of the rotor are skewed at an angle to the axis of the rotor.

6. The motor of claim 4, wherein the slots are filled with a material selected from the group of aluminum, aluminum alloy, copper, copper alloy, brass, bronze, and high resistance non-metallic materials.

7. The motor of claim 4, wherein the spaced relationship between the slots and grooves is such that each groove is between a pair of slots.

8. The motor of claim 4, wherein a cross-sectional shape of each slot is substantially the same.

9. The motor of claim 8, wherein the slot spacing is generally symmetrical.

10. The motor of claim 4, wherein a cross-sectional shape of each groove is substantially the same.

11. The motor of claim 4, wherein the slot spacing is non-symmetrical.

12. The motor of claim 4, wherein the spaced relationship between the slots and the outer surface is such that each slot is generally the same distance from the outer surface.

14. The motor of claim 4, further including an end ring at one end of the slot on the rotor.

15. A method of providing axial flow of gas in an induction motor submerged in a fluid, including the steps of:
operating the motor to cause a rotor to rotate about a cylindrical axis of the cylinder; and
pumping gas along the axial length of the cylinder through spiral grooves in an outer surface of the cylinder.

16. A method of providing axial flow of fluid in an induction motor submerged in fluid, including the steps of:
operating the motor to cause a cylinder in the motor to rotate about a cylindrical axis of the cylinder; and
pumping fluid along the axial length of the cylinder through spiral grooves in an outer surface of the cylinder.
